(19) United States
(12) Patent Application Publication
(10) Pub. No.: US 2005/0282124 A1
(43) Pub. Date: Dec. 22, 2005

(54) Sine of the time

(76) Inventor: Eric Anderson, Ormond Beach, FL (US)

Correspondence Address: Eric Anderson, 7 Soco Trail, Ormond Beach, FL, 32174, US

(21) Appl. No.: 11/211,912

(22) Filed: Aug. 24, 2005

Related U.S. Application Data
(63) Continuation-in-part of application No. 10/794,921, filed on Mar. 8, 2004.

(51) Int. Cl. G09B 23/02

(52) U.S. Cl. 434/211

(57) ABSTRACT

An improved instructional method, whose advantage is in being directed and focused upon the point of math education where students are introduced to the three correlated nomenclatures of angle measure; degrees, radians, and gradians. This device removes the obfuscating array of incrementation marks, that are found piecemeal in the existing body of prior art, from the conventional circle design and replaces them with only the marks of incrementation that are already well known to the student at the time of their introduction to the various nomenclatures of angle measure; 24 hour incrementations, and 60 minute incrementations. The amount of equal angle measure through which the radius line pointer may be rotated is then clearly stated upon the design for both, the hour marks and minute marks of incrementation; π/12 radians=50/3 grads=15 degrees, and π/30 radians=20/3 grads=6 degrees, respectively.

### CROSS-REFERENCE TO RELATED APPLICATIONS

This application is filed as a Continuation-in-Part of application Ser. No. 10/794,921 filed on 8 Mar. 2004, now abandoned.

### FEDERALLY SPONSORED RESEARCH

Not Applicable.

### REFERENCE TO SEQUENCE LISTING

Not Applicable.

### BACKGROUND OF THE INVENTION

1. Field of the Invention

This invention pertains to the field of mathematics, specifically to the subject matters of angle measure, trigonometry, and geometry.

2. Prior Art

All scientific calculators are programmed to perform trigonometric calculations upon angle measures in any of three different nomenclatures; degrees, radians, and gradians (also known as grads). Yet, introductory instructional materials persist in teaching only one of these nomenclatures at a time (usually degrees), or in teaching them separately depending upon a demonstrated application. In fact, within the subject of circle geometry, radian (because it is directly related to radius) is the nomenclature of angle measure that is used to determine both circle arc lengths and circle sector areas. Lack of understanding in the general educated populous that the symbol π in the formula for total circle area, πr², is a reference to radian angle measure (it is simplified, when θR=2π, from the formula; Circle Sector Area=½θRr²) is evidence of a serious fault that exists at the introduction of the subject matter to the new learner.

Though there are many previous products that contain aspects related to the ubiquitous incremented circle scale—such as U.S. Pat. No. 5,215,467 (Brischke, 1993) marked with degrees to visually demonstrate lines, angles marked in degrees, shapes and their relationships; U.S. Pat. No. 3,347,459 (Thiel, 1967) discs joined at their center points which represent the center of the sun, marked with degrees and hours, and a 1440 minute scale, for use in space and terrestrial navigation; U.S. Pat. No. 6,243,959 (Monck, 2001) a straightedge ruler for taking linear measurements; U.S. Pat. No. 1,676,912 (Meacham, 1928), a device for use in the calculation of time by the means of the position of certain stars, and; U.S. Pat. No. 3,795,053 (Burke, 1974) a drafting instrument whose perimeter is marked in degrees-none presents but a part of the material of this inventor's submission, or they are focused on lessons or applications that teach away from the lesson of this inventor's submission and are thus incomplete or obfuscating toward the goal of the submitted method.

### OBJECTS AND ADVANTAGES

The value of visual aids is well known and accepted in the fields of math and science education. The differences then, between this inventors device and the prior art are greater than that the subject matter as a whole would have been decipherable to those skilled in the art. The need for a device of comprehensive primary introduction to the three methods of angle measure is a lesson that is too easily overlooked by those skilled in the art, who were (it may be surmised) exposed to the material long ago, and hence fail, in the necessary exercise, to see the subject matter as it appears upon first introduction to the new learner. This applicant submits a method of educational voracity that redacts the math lesson at hand, as it relates to introducing the three nomenclatures of angle measure and their correlation, by using a conventional time clock numeration as factors common to all three full-circle angle measures (2π Radians, 400 Grads, and 360 Degrees), into an invention that is at once simpler and superior to what might be found piecemeal in the prior art.

### SUMMARY OF THE INVENTION

This invention uses the conventional circle design to concurrently introduce the three nomenclatures of angle measure; degrees, radians, and gradians. This is accomplished by removing extraneous information from the marked perimeter of the conventional circle design, and showing just the common factoring of the well-known 24 hour and 60 minute clock-face indicia. Also, expressly stated upon the visual aid, is the equal amount of angle measure (in degrees, radians, and grads) between any two consecutive marks of either the minute factor scale or the hour factor scale. The simple method of multiplying an indicated clock-face factor number by any one of the three equal amounts of angle increment is also shown upon the design in the preferred embodiment (i.e. θ=factor×increment).

### DRAWINGS

FIG. 1 shows the relevant elements of the invention in frontal view.

FIG. 2 shows an example of a right-triangle formed from a corresponding subject angle, with side-opposite and side-adjacent lengths from which trigonometric values of the subject angle may be determined.

### DETAILED DESCRIPTION OF THE PREFERRED EMBODIMENT

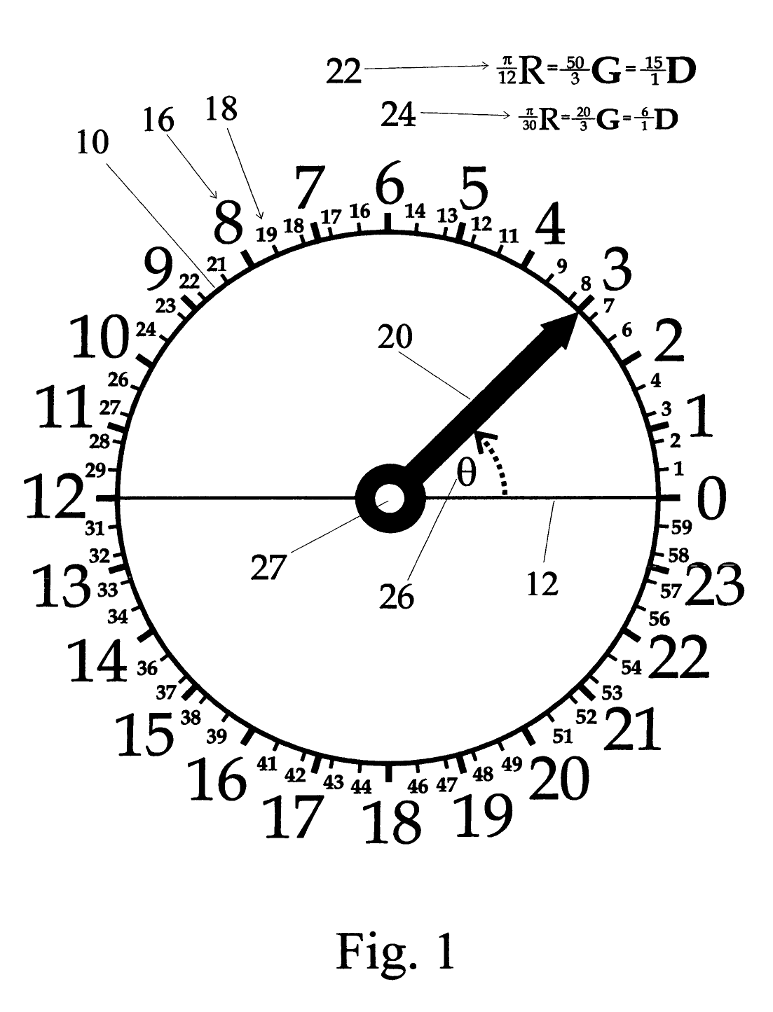

Please refer to FIG. 1:

In the preferred embodiment, the elements of the following description are printed on letter size card stock or cover stock substrate, which substrate is then laminated within plastic laminating film. Subsequently, it would normally have the below described rotatable pointer attached at the center of the below described circular design.

This invention is comprised of a circle 10 with a baseline 12 that is the horizontal line of diameter of said circle 10. There are two sets of numbered incrementations marked in the counter-clockwise direction and regularly spaced along the entire circumference of the circle 10 and they are the hour factor incrementations 16, and the minute factor incrementations 18. The zero mark of both sets of numbered incrementations is located at the right side intersection of said baseline 12 with the circumference of the circle 10. A flat plastic radius line, triangle hypotenuse line, pointer 20 is attached at its mounting end by grommet or eyelet, or some similar method, at the center of the circle 10, which attachment allows the pointer 20, to be rotated by human hand manipulation around the circle 10 such that the arrowhead end of the pointer 20 tracks along the circumference of the circle 10.

There is also shown upon the surface of this invention's design the equal values of angle measure of radians ‘R’, gradians ‘G’, and degrees ‘D’ that exist between every two adjacent marks of hour factor incrementations 16 and the equal values of angle measure of radians ‘R’, gradians ‘G’, and degrees ‘D’ that exist between every two adjacent marks of minute factor incrementations 18, through which the pointer 20 moves when it is rotated from one mark of incrementation to the very next mark of incrementation of the same set of marks. These equal values of angle measure between two adjacent marks of the hour factor incrementations 16 are π/12 radians=50/3 grads=15 degrees 22, and these equal values of angle measure between two adjacent marks of the minute factor incrementations 18 are π/30 radians=20/3 grads=6 degrees 24.

Please note that the set of hour factor incrementations 16 and the set of minute factor incrementations 18 are not combined or cumulative in the determining of angle measures (see ‘Operation’, below), but that a person will use one set of factor incrementations, with its corresponding values of angle increment, independently of the other.

Operation:

Angles, indicated by the Greek symbol theta ‘θ’ 26, are measured upon this design, in the counter-clockwise direction, between the right half of the baseline 12 and the line of the pointer 20, with the vertex 27 of the angles being at the center of the circle 10. The value of the angle indicated by the position of the pointer 20 is the product of the multiplication of the numbered factor incrementation mark by the value of angle increment that corresponds to such pointer indicated number. For example, when the pointer 20 is pointed at the hour factor incrementation mark ‘3’ of the hour factor incrementations 16, the actual angle measurement that is formed at the vertex 27, between the right half of the baseline 12 and the line of the pointer 20 is determined by multiplying that ‘3’ by one of the angle increment measures of π/12 radians or 50/3 grads or 15 degrees 22, depending upon which nomenclature within which a student might be working, or perhaps depending upon which nomenclature might be assigned by a student's math instructor. The respective answers of this example are then π/4 radians or 50 grads or 45 degrees, which are all equal values of angle measure, as they should be.

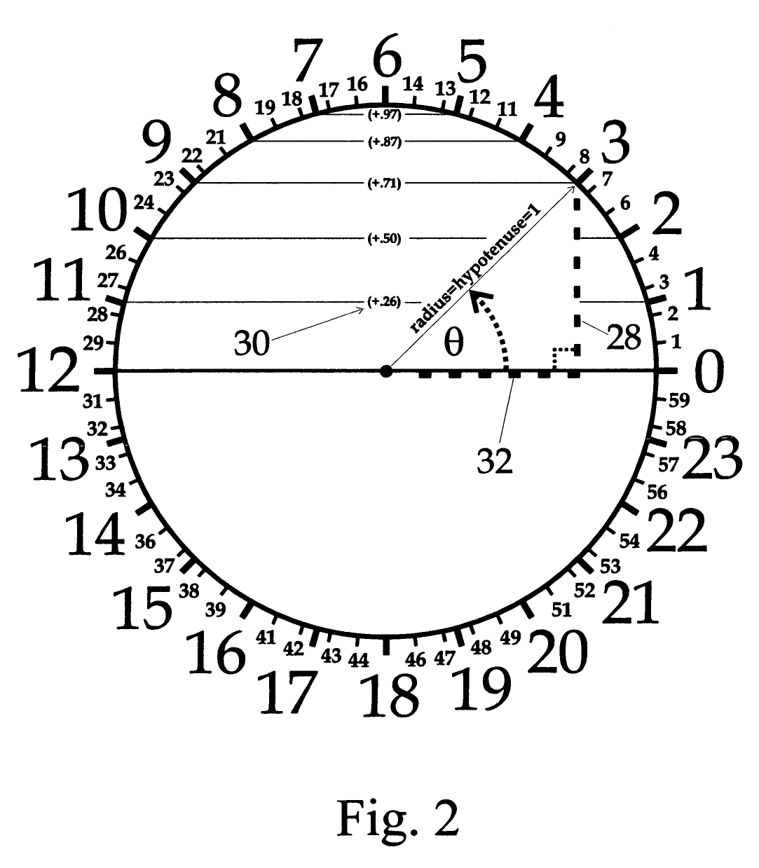

Please refer to FIG. 2:

In the preferred embodiment, the example discussed above is also preprinted on the substrate material, expressly stating the exemplar length value of the radius line, hypotenuse line, pointer 20. FIG. 2 shows this printing without the subsequently attached pointer 20.

In addition to representing a radius line of the circle 10, said pointer 20 also represents (as stated previously) the hypotenuse side of any right-triangle that may subsequently be formed, from any central subject angle ‘θ’ 26, by drawing a straight vertical line from the tip of the pointer 20 to the baseline 12. Said vertical line is then a side-opposite 28, to the subject angle ‘θ’ 26, of the three sides of a formed right-triangle. A side-adjacent 32 is then also formed between the intersection of said side-opposite 28 with the baseline 12, and the vertex 27 of the subject angle.

Printed values 30 that represent side-opposite 28 lengths, which lengths correspond to the right-triangles that may be formed for the ‘on-the-hour’ values of angle measure, are also shown upon the design. These printed values 30 of side-opposite 28 lengths correspond to a hypotenuse length value of ‘1’. Note that the negative, or vector, values of the lengths of side-opposite 28 for the on-the-hour angle measures that are below the baseline 12 are not shown, simply in order to avoid cluttering the design. Also, please note that when the printed values 30 are transposed 90 degrees, or π/2 radians, or 100 grads, clockwise on the design, they then become the values of the side-adjacent 32 lengths for the right-triangles formed from said ‘on-the-hour’ angle measures. The user then has the values needed to derive any of the six basic trigonometric functions from these printed values 30, as all six trigonometric functions are determined by using two of the three values of the lengths of hypotenuse, side-opposite, and side-adjacent. For example, sine θ=opposite/hypotenuse. This differs from the prior art in that it shows the required components for the derivation of trigonometric values, which is far superior in the matter of teaching, than the mere listing of precalculated trigonometric values.

It is also a paradigm of the preferred embodiment that the baseline 12 may be viewed as a single ray of sunlight passing from the center of the sun through the center of the earth. The circle 10 then represents the earth spinning counter-clockwise, as if viewed from above its north-pole. This then becomes an effective tool for teaching time to younger students, and provides an additional tool to aid in visualizing how trigonometric values change as the lengths of the sides of the right-triangles, from which they are determined, also change.

### CONCLUSIONS

Those who use scientific calculators are exposed, in an ongoing basis, to the mode feature of these calculators wherein angle measure may be displayed in degrees, radians, or grads. Ironically, many individuals who consider their selves to be proficient at number handling remain unfamiliar to radian and grad angle measure, and this is even true of elementary instructors of mathematics. This is especially unfortunate when it is considered that radian angle measure is most closely associated to the geometry of circles. This Applicant's invention supersedes the prior art at manifesting the obviousness, in the inherent lesson, that should long have been a much clearer part of mathematics education. This is accomplished in a product that is economical to produce, and that will be visually interesting to the new learner.

Although the description above contains the necessary specificities, these should not be construed as limiting the scope of the invention but as merely providing illustrations of the presently preferred embodiment of this invention. Thus the scope of the invention should be determined by the appended claims and their legal equivalents, rather than by the examples given.

1. Applicant claims an improved instructional method of circular design with a baseline and a rotatable pointer for concurrently and succinctly teaching the comprehensive relationship between the three modes of angle measure, comprising:
a. showing upon the substrate only the numeration of the common 24 hour and 60 minute sets of incrementation marks, advancing in the counter-clockwise direction and regularly spaced, upon the circumference of said circular design, and
b. stating explicitly upon the surface of said instructional design, the equal values of angle increment that occur between any two corresponding consecutive numbers of said sets of incrementation marks as π/12 radians=50/3 grads=15 degrees for the hour set of said incrementation marks, and π/30 radians=20/3 grads=6 degrees for the minute set of said incrementation marks,
whereby the angle measure formed at the center of said circular design by the accumulated rotational distance from the right half of said baseline to the line of said pointer, is determined by multiplying the number indicated by said pointer, times any of the three corresponding equal values of angle increment.
